(19) United States
(12) Patent Application Publication
(10) Pub. No.: US 2015/0004591 A1
(43) Pub. Date: Jan. 1, 2015

(54) DEVICE, SYSTEM, METHOD, AND COMPUTER-READABLE MEDIUM FOR PROVIDING AN EDUCATIONAL, TEXT-BASED INTERACTIVE GAME

(71) Applicant: DoSomething.Org, New York, NY (US)

(72) Inventors: Marah LIDEY, New York, NY (US); Alysha BOLOGNO, New York, NY (US); Jonathan UY, New York, NY (US); Mike FANTINI, New York, NY (US); Nancy LUBLIN, New York, NY (US)

(21) Appl. No.: 13/929,397

(22) Filed: Jun. 27, 2013

(51) Int. Cl. G09B 7/077; H04W 4/12; H04W 4/14; G09B 7/08

(52) U.S. Cl. CPC G09B 7/077; G09B 7/08; H04W 4/12; H04W 4/14
USPC 434/351

(57) ABSTRACT

A method, device, system, and computer medium for implementing and/or providing an educational, text-based, interactive game are provided. For example, a server may be connected to a plurality of communication devices. The server may include: a receiver that receives a first text from a first mobile communication device; a message determination unit that determines a second text to be sent to the first mobile communication device, in response to the first text, such that a user of the first mobile communication device and the server system continue an interactive conversation path; and a language scripter that customizes the second text based on, at least, a plurality of messages that have been received from the first mobile communication device.

### FIELD OF THE INVENTION

The present invention relates to a device, system, method, and computer-readable medium for providing text-based interactive gaming, and the following description is made with reference to this field of application for convenience of explanation only.

### BACKGROUND OF THE INVENTION

The vast majority of the youth population nationwide and worldwide has cellphone accessibility, and consequently, text-based communication such as SMS/MMS is one of the most effective and efficient way of communicating with the youth population.

Accordingly, text-based communication may be the most effective way of running cause campaigns around various issues that teenagers care about, for example, providing them with simple calls to action.

Further, a high percentage of people in the young generation demonstrate improved engagement and attentiveness when an issue is presented in an interactive gaming format. Accordingly, implementing text-based (e.g., SMS/MSS) interactive gaming for various social causes may help many young people to become more engaged, attentive, and educated on various social issues and/or causes, and ultimately benefit the society as a whole.

Accordingly, described herein are an apparatus, method, system, and computer readable medium for providing and/or implementing a text-based interactive game.

### SUMMARY OF THE INVENTION

Described herein are apparatus, method, system, and computer readable medium for providing and/or implementing a text-based interactive game for various social causes, issues and goods.

The various social causes, issues and goods may include, but are not limited to, a teen pregnancy issue, a history of activists in the 1960s, a bullying issue, and a value-test where a series of value-choice questions may be presented and aggregate answers of one player may be compared with those of others.

Further, one or more users may interact with the server and with each other individually or jointly via SMS or MMS or any equivalent text-based communication method or service.

The claimed contents of the present application are not limited to the technological concept described below, but are described in the claims of the present application.

According to some embodiments, a server system may host an educational text-based interactive game for a plurality of mobile communication devices. The server system may include: a receiver that receives a first text from a first mobile communication device; a message determination unit that determines a second text to be sent to the first mobile communication device in response to the first text, wherein the first mobile communication device responds to the second text to continue an interactive conversation path between the first mobile communication device and the server system; a language scripter that customizes the second text based on, at least, a plurality of messages that have been received from the first mobile communication device during the game; and a transmitter that transmits the customized second text to the first mobile communication device.

The receiver may receive a third text from a second communication device, and the message determination unit may determine the second text based on both the first text received from the first communication device and the third text received from the second communication device.

The texts that are exchanged between the first communication device and the server system may be in the SMS or MMS format.

The first mobile communication device may include a cellphone, a tablet computer, a PDA, or a device supporting SMS or MMS communication.

The language scripter may customize the second text based on information associated with each of the plurality of messages, the information including at least a time, date, or location associated with transmission or receipt of the respective messages.

The server system may further comprise a storage medium that stores aggregate text messages that have been received from the first communication device, wherein the language scripter may customize the second text based on, at least, a language style of all of the aggregate text messages stored on the storage medium, the language style including at least a frequency of a word, an average length of sentences, or a frequency of a grammar mistake.

The plurality of messages may be an aggregate of all messages that have been received from the first mobile communication device.

The message determination unit may determine the second text based on both an aggregate of texts previously received from the first communication device, including the first text, and an aggregate of texts previously received from the second communication device, including the third text.

The language scripter may customize the second text based on information associated with each of the aggregate of messages from the first and second communication devices, the information including at least a time, date, or location associated with transmission or receipt of the respective messages.

The server system may further comprise a result-generator that generates a result of the game for the user of the first communication device based on at least a comparison of the aggregate texts received from the first communication device and aggregate texts received from other devices during the game.

The message-determination unit may determine the second text among a plurality of scheduled messages, based on a scheduling condition associated with each of the messages.

The scheduling condition may include a time of the day, location associated with the first communication device, or time lapsed from a last message sent.

If the user of the first communication device does not respond to the second text sent by the server system within a predetermined amount of time, the server system may recognize the user's non-action, and the message determination unit may determine a subsequent message to be sent to the user based on at least the user's non-action.

According to some embodiments, a method may be used to host an educational text-based interactive game for a plurality of communication devices, using a server system remotely connected to the communication devices. The method may comprise: receiving a first text from a first mobile communication device; determining a second text to be sent to the first mobile communication device, in response to the first text, wherein the first mobile communication device responds to the second text to continue an interactive conversation path between the first mobile communication device and the server system; customizing the second text based on, at least, a plurality of messages that have been received from the first mobile communication device during the game; and transmitting the customized second text to the first mobile communication device.

According to some embodiments, a non-transitory computer readable medium may be used to host an educational text-based interactive game. The non-transitory computer readable medium may be included in a server system with a processor and may store instructions for hosting the game. When the instructions are executed, the server system may be caused to perform the following: receiving a first text from a first mobile communication device; determining a second text to be sent to the first mobile communication device, in response to the first text, wherein the first mobile communication device responds to the second text to continue an interactive conversation path between the first mobile communication device and the server system; customizing the second text based on, at least, a plurality of messages that have been received from the first mobile communication device during the game; and transmitting the customized second text to the first mobile communication device.

### BRIEF DESCRIPTION OF THE DRAWINGS

The characteristics and advantages of the device, system, method, and computer-readable medium for providing text-based interactive gaming, will be explained with reference to the following description of embodiments thereof given by way of indicative and non-limiting examples with reference to the annexed drawings, in which:

FIG. 1 schematically illustrates an example of a network system that may be used to implement text-based interactive gaming, in accordance with some embodiments described herein.

FIGS. 2A and 2B illustrate an example of a processing flow chart of a text-based randomized game 200, in accordance with some embodiments described herein.

FIG. 2A illustrates an exemplary processing flow chart from an alpha-user's perspective in the text-based randomized game 200, in accordance with some embodiments described herein.

FIG. 2B illustrates an exemplary processing flow chart from a beta-user's perspective in the text-based randomized game 200, in accordance with some embodiments described herein.

FIGS. 3A-3C illustrate an example of a processing flow chart of a text-based interactive game 300, in accordance with some embodiments described herein.

FIG. 3A illustrates an exemplary processing flow chart of the first interactive path in the text-based interactive game 300, in accordance with some embodiments described herein.

FIG. 3B illustrates an exemplary processing flow chart of the second interactive path through second to last interactive path in the text-based interactive game 300, in accordance with some embodiments described herein.

FIG. 3C illustrates an exemplary flow chart of the last interactive path in the text-based interactive game 300, in accordance with some embodiments described herein.

FIG. 4 illustrates exemplary scenarios for different users' text message interactions with the server, in accordance with some embodiments described in FIGS. 3A-3C.

FIGS. 5A and 5B illustrate examples of a processing flow chart of a text-based interactive game 500, in accordance with some embodiments described herein.

FIG. 5A illustrates an exemplary processing flow for an alpha user in the text-based interactive game 500, in accordance with some embodiments described herein.

FIG. 5B illustrates an exemplary processing flow for a beta user in the text-based interactive game 500, in accordance with some embodiments described herein.

### DETAILED DESCRIPTION OF THE INVENTION

The text-based interactive gaming system according to some embodiments described herein may include apparatuses, systems, methods, and computer-readable mediums for implementing and providing a text-based interactive game with improved real-time interactivity to one or more users via texts (e.g., SMS, MMS or anything equivalent thereof).

The interactivity may be established among different users or between users and a remotely-connected server. For example, players may respond or act on various texts sent from the server and/or various texts or actions performed by different players who have opted to participate in the player's game. Players' past interactions in aggregate may affect what kind of social condition or environment will be simulated, and the past interactions may include, but are not limited to, the players' cumulative responses/messages/actions that are previously made, dates and times associated with each of the cumulative responses, cumulative responses from other players and their history of record, etc.

In particular, the interactive text-based gaming system may leverage SMS technologies to allow users to send custom messaging based on keywords, send MMS, send robocalls, send custom messaging based on liquid language, allow users to invite friends (e.g., other users), allow users to opt-in via web form, and allow users to self-select frequency of messaging.

The interactive text-based gaming system may further allow positive feedback loops between multiple users, utilize various tools to randomize messaging, enhance the ability to submit SMS and/or MMS automatically to online web forms, incorporate Natural Language Processing (e.g., customizing messages based on individual player's natural language characteristics) in SMS/MMS, recognize and utilize neglect paths (e.g., user's non-responsiveness) to enhances interactivity, share-ability, and a more seamless user experience in a text-based environment (e.g., SMS and MMS).

One of the representative examples of a technological concept of the present invention will be described more fully hereinafter with reference to the accompanying drawings, in which illustrative embodiments of the present invention are shown. These examples may, however, be embodied in many different forms and should not be construed as limited to the embodiments set forth herein; rather, these embodiments are provided so that this disclosure will be thorough and complete, and will fully convey the scope of the claims to those skilled in the art. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the claimed subject matter.

The terminology used herein is for the purpose of describing particular embodiments only and is not intended to limit the claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

As will be appreciated by one of skill in the art, the claimed subject matter may be embodied as a method, device, data processing system, or computer program product. Furthermore, the claimed subject matter may take the form of a computer program product on a computer-usable storage medium having computer-usable program code embodied in the medium. Any suitable computer-readable medium may be utilized including hard disks, CD-ROMs, optical storage devices, a transmission media such as those supporting the Internet or an intranet, or magnetic storage devices.

Computer program code for carrying out operations of the embodiments of the claimed subject matter may be written in an object-oriented programming language such as Java®, Smalltalk or C++. However, the computer program code for carrying out operations of the embodiments of the claimed subject matter may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The claimed subject matter is described in part below with reference to flow chart illustrations and/or block diagrams of methods, apparatus (systems), and computer program products according to embodiments of the claimed subject matter. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flow chart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

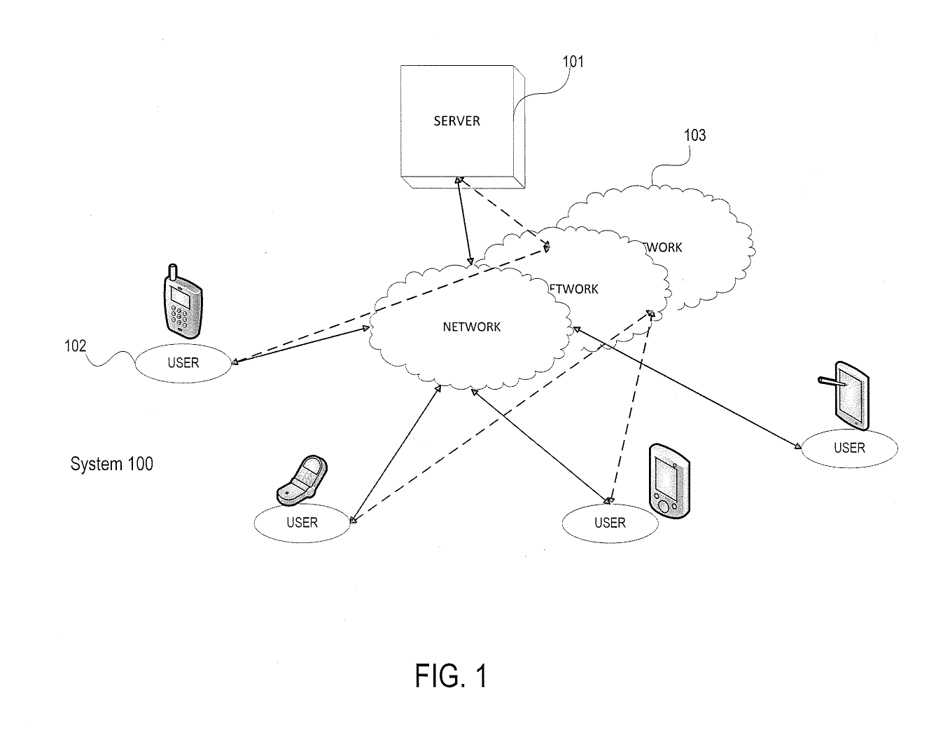

Several exemplary embodiments of the claimed subject matter will be described with respect to FIGS. 1-5B below. Embodiments provide methods, device, systems, and computer program products for providing an interactive text-based gaming system. This effort may allow users to send custom messaging based on keywords, send MMS, send robocalls, send custom messaging based on liquid language, invite friends (e.g., other users), opt-in via webform, and self-select frequency of messaging, and the system may further enable positive feedback loops between multiple users, tools to randomize messaging, enhancing the ability to submit SMS and/or MMS automatically to online webforms, incorporate Natural Language Processing in SMS, the use of neglect paths and any technology that enhances interactivity, share-ability, and a more seamless user experience in a text-based environment (e.g., SMS and MMS).

The glossary of selected terms that are used throughout this disclosure is provided herein.

“Alpha user” means the user who invites another user to an SMS game.

“Beta user” means the user who is invited by another to an SMS game.

“Conversation” means the exchange of messages between an end user and backend system that make up the core experience of an SMS game. This may also refer to the actual preset structured conversations between user and system that are set up in the Mobile Commons platform.

“Mobile Commons” is the third party mobile platform that all SMS and MMS messages are sent through and received from. Select user data and user responses may also be stored here.

“Drupal” means a web platform on which the code implementing the interactive text-based gaming is run in order to drive certain aspects of a conversation. This may be also utilized to store data about users, users' responses, and user relationships (e.g., who was invited by whom).

“Keyword” means a unique word or series of characters a user can text in order to trigger certain actions, such as, non-exclusively, the start of a mobile conversation.

“Scheduled messages” means a series of preset messages that are set up within Mobile Commons to broadcast to a user at specific times and intervals.

“Liquid” means a template scripting language for creating dynamic text message responses based on user data in the Mobile Commons database.

“MDATA” means a Mobile Commons web service that allows for custom code for implementing the interactive text-based gaming and web applications to interface with the Mobile Commons platform.

“NLP” means an abbreviation for Natural Language Processing, which refers to algorithms used to interpret the natural human language texted from users to backend systems, and methods for responding to them.

“TECH•DS” refer to items created by custom technology via source code implemented on backend systems.

“TECH•MC” refer to items created by custom technology driving interactions through the Mobile Commons platform. The logic and configuring of this technology to drive these interactions may be customized.

FIG. 1 schematically illustrates an example of a network system that may be used to implement text-based interactive gaming, in accordance with some embodiments described herein. A text-based interactive gaming system 100 may include a server 101, one or more users 102, and one or more networks 103.

User 102 may communicate with server 101 and with other users 102 via texts. The texting by user 102 may be enabled through various devices, such as, non-exclusively, a cellphone, a smartphone, a PDA, a pad or tablet computer, etc.

A user device may have an input unit for inputting text data. The input unit may be embedded in the device or externally connected to the device. The input unit may include a keyboard, a keypad, a joystick, a roller, a touch pad, a touch screen, a stylus pen for touch screens/pads, or any equivalent thereof.

User 102 may communicate with server 101 through one or more networks 103, which may include, non-exclusively, a mobile network, Internet, or any other networks (including proprietary networks) that may enable text-based communications.

Server 101 may comprise a non-transitory computer-readable medium that stores a computer-executable program. Server 101 may further comprise a processor to execute the stored program to enable various types of interactions among users 102 and server 101. Server system 101 may comprise one or more computers or processors capable of executing computer-readable instructions. An interface between the server 101 and network 103 may be provided by one or more gateways, such as, the Mobile Commons.

Further, server 101 may store responses from user 102, any information associated with particular responses from user 102 (e.g., dates and times, content of the responses, keywords associated with the responses, transmitter/receiver of the responses, etc.), and based on such cumulative information, generate different gaming experience and environments for user 102.

The responses that will affect the gaming experience for user 102 may include not only the user's cumulative responses but also the cumulative response from other users who might have been invited to join the game. This effort may enable enhanced interactivity not only between the user and the server but also among different users and the server.

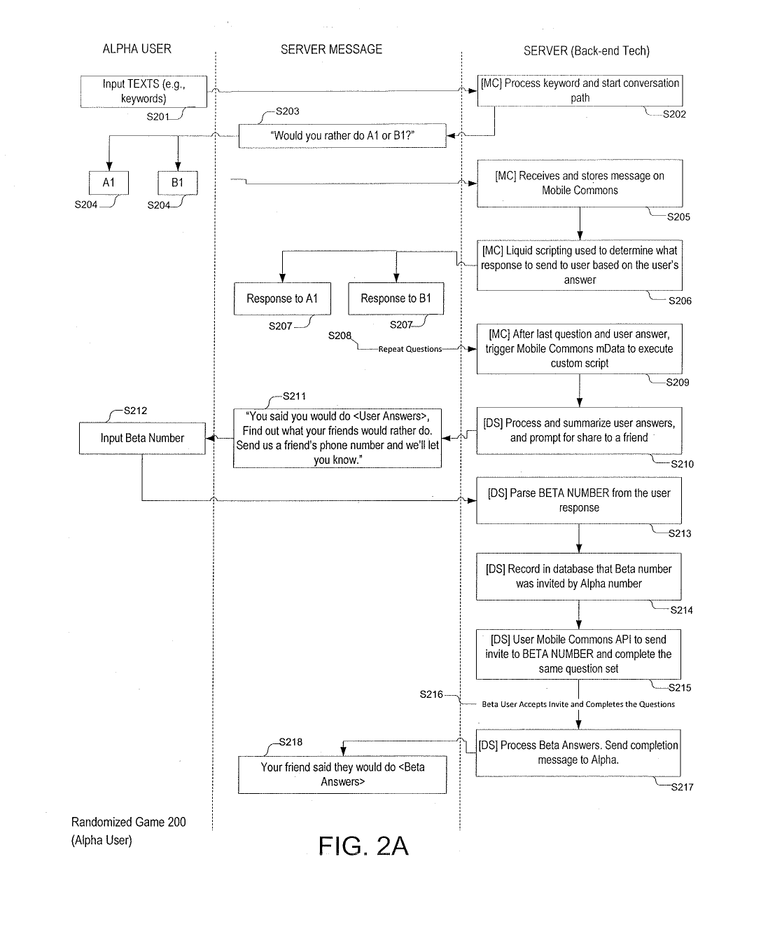

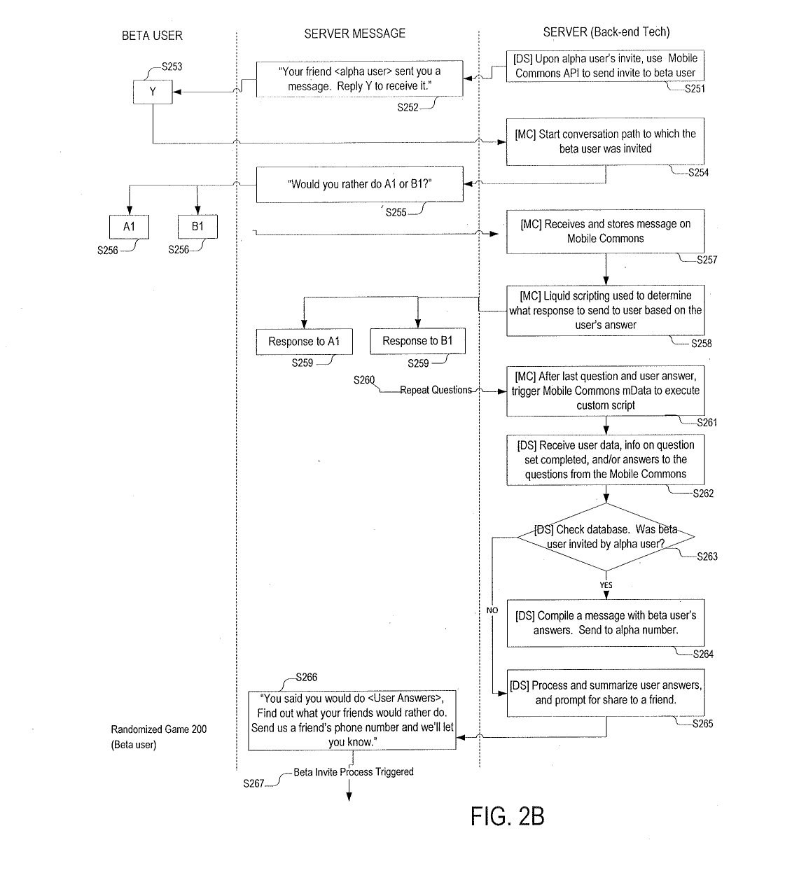

Several different exemplary games will be described below with reference to FIGS. 2A-5B. These games are disclosed herein only as examples, and are substantially simplified for the convenience of explanation. One of ordinary skill in the art reading the disclosure herein will recognize that all apparent modification to the apparatuses, methods, systems, and computer-readable mediums described herein are part of the same disclosure and within the scope of the claims.

FIGS. 2A and 2B show an example of a processing flow chart of a text-based randomized game 200, in accordance with some embodiments described herein. FIG. 2A shows an exemplary processing flow chart from an alpha-user's perspective, and FIG. 2B shows an exemplary processing flow chart from a beta-user's perspective.

The randomized game 200 may include the “Would You Rather Randomized Quiz Game,” whose game model presents players with a set of questions and provides a custom response at the end based on those answers. The randomized game 200 may allow players to invite friends to participate in the game, while offering a channel in which users may be notified of the answers of the friends they invited.

FIG. 2A outlines the user flow and server tech behind the experience of an initial user entering the game via a keyword. For an alpha user who invited a friend to take part in the game, FIG. 2A shows the process in which an alpha user will receive additional message informing him/her what his friend's choices were.

FIG. 2B outlines the user flow and server tech behind the experience of an invited user (beta user) entering the game via an invitation from an alpha user. Specifically, FIG. 2B illustrates the process in which the beta user completes the question set, triggers a message back to the alpha user, and is prompted to continue the invitation loop to see other friends' answers.

Referring to FIG. 2A, an alpha-user may input texts that include keywords to trigger the randomized game 200, as shown in S201. The back-end technology implemented in the server may recognize and process the keywords in the alpha user's texts and subsequently start the conversation path corresponding to the keywords, as shown in S202.

For example, one or more keywords may be associated with a “Would You Rather Randomized Quiz Game,” and such keywords may trigger the server to start a conversation path corresponding to that game. Different keywords may be associated with different games and accordingly with different conversation paths.

The processing of keywords may be done at the Mobile Commons level implemented in the server. In fact, [MC] refers to features and technologies implemented at the “Mobile Commons” level and/or interface, and [DS] refers to features and technologies implemented at a different level through computer-readable code that may be executed by a processor in the server. The [DS] may be customized with more flexibility than with the Mobile Commons.

At S203, the server starts the conversation path corresponding to the “Would You Rather Randomized Quiz Game” by sending a text message asking the user to choose between A1 and B1. The message may take the following form, “Would you rather do A1 or B1?,” or any other equivalent form that may force the user to choose one of the select options. “A1” and “B1” are different actions or preferences that the user may choose in a particular situation, condition, or environment.

The above information may be pre-stored in the server, and the question corresponding to the user-specific information may be used to start the conversation path. The user-specific information may include, non-exclusively, the keywords inputted in the user's texts, the type of user's device, the type of network the user's message came through, the area code associated with the user's phone number, the location of access point of the user's connection, etc.

At S204, the user is prompted to select A1 or B1. The user may make a selection via texts, which may be inputted using an input device of the user's device.

At S205, the Mobile Commons may receive and store the user's selection message. Subsequently, at S206, the server may use the liquid scripting to determine a template scripting language to generate dynamic text message responses based on the user's data stored in the Mobile Commons database.

The user's data may include all the previous messages that are cumulatively stored in the Mobile Commons database, the dates and times information associated with each of the previous messages, and/or any specific features associated with the user such as the type of the user's device, any personal information associated with the user's device and/or phone number, the user's current or past location, etc.

At S207, the server sends a determined response to the user. Here, the user may likely receive different responses based on the user's selection to choose A1 or B1.

The server repeats the above process of generating a question based on user-associated information (including both the user-specific information and the general information such as the current weather, publicly available news, etc.) to force the user to choose one of the select options, processing the user's selection, and then generating a next question further based on the cumulative user-associated information including the immediately prior response as well as all the previous responses that are made before that. This is represented in S208.

Specifically, the liquid scripting or custom scripting may customize a message based on information associated with each of the aggregate text messages. The information may include, but not limited to: contents of the messages, language style of the message (e.g., frequency of certain words in use, average length of sentences, frequency of certain grammar mistakes, types of frequently-made grammar mistakes, frequently-used pattern of certain combination of words, etc.), generic associative information such as, for example, time, date, and/or location associated with transmission and/or receipt of each of the aggregate messages.

The question set (the types and/or the content of questions), and/or the question path (the order of the questions) may be customized for individual users based on the user's cumulative information, as explained above. Accordingly, the users may be provided with the customized and/or unique gaming experience with respect to the types and contents of the questions as well as to the specific order of the question set.

After the question set is complete, and the user inputs a text response to the last question of the question set, the server may trigger the Mobile Commons mData to execute the custom script, as shown in S209. Subsequently, at S210, the server may process and summarize the user's responses to store in the server and/or return to the user. Further, the server may also prompt the user to share the game with a friend.

The processing and summarizing the user's answers may be done at the source code level executed by a processing in the server, which may not involve the Mobile Commons. For example, the server may import the cumulative information stored in the Mobile Commons, and process the cumulative information to generate a summary. The summary may be a literal summary of the user's responses, or may be an outcome of the user's cumulative responses after having gone through a pre-set algorithm by the server. Further, the summarizing of the alpha user's answers may include pulling the data from the Mobile Commons and compiling it into a user-friendly message, which may be kept under the 160 character SMS limit.

As shown in S211, the server may send a message to the user, showing the user's answers and prompting the user to share with a friend. In response to the prompt, the user may input a beta user's number, as shown in S212.

The server may parse the beta user's number from the alpha user's response, as shown in S213, and then record in the database that the beta user's number was invited by the alpha user's number, as shown in S214. Such information may become part of the cumulative information of either or both the alpha user and the beta user, which may affect the respective user's gaming experience.

At S215, the server may send an invitation to the beta user's number using the Mobile Commons API and complete the questions set for the beta user. The process of completing the question set for the beta user may be similar to the process explained above for the alpha user, and an example of such process is provided in FIG. 2B.

After the beta user completes the question set, as shown in S216, the server may similarly process the beta user's answers and send a completion message to the alpha user, as shown in S217. An exemplary message is shown in S218.

FIG. 2B shows an exemplary processing flow chart, as may apply to the randomized game 200 in FIG. 2A, from the beta-user's perspective.

Upon the alpha user's invitation to the beta user, the server uses the Mobile Commons API to send an invitation message to the beta user's number identified by the alpha user, as shown in S251. An exemplary message sent by the server is shown in S252. The alpha user may be identified by the alpha user's number or any characters or numbers pre-associated with the alpha user.

The beta user may send a text including a keyword identified in the message to accept the invitation, which in this example is “Y,” as shown in S253. Upon the beta user's acceptance, the Mobile Commons may start the conversation path to which the beta user was invited by the alpha user, as shown in S254. The alpha user may invite the beta user to the same conversation path, or to different paths.

The same conversation path does not necessarily mean the same set and/or the order of the questions. Instead, the actual content and order of the questions may be customized for different users because they may be determined based on the user's specific responses and cumulative information stored in the server. The same conversation path may mean the questions to be asked to the players are drawn from the same broader set of questions, wherein only a subset of this broader set is to be selected and asked to the users in the game. Accordingly, even if different users are playing the same conversation path, the users may get different questions in different orders.

In the example shown in FIG. 2B, the alpha user invited the beta user to the same conversation path, which may start with the same initial question, as shown in S255. The beta user may choose one of A1 and B1 by sending a text including the keywords associated with the selected choice, as shown in S256.

The Mobile Commons may receive the beta user's text message and store it, as shown in S257. When the message is stored, it is associated with the beta user and consequently becomes part of the beta user's cumulative information stored in the server.

The Mobile Commons then uses the liquid scripting to determine a response to be returned to the beta user based on the beta user's cumulative information stored in the server, as shown in S258. For example, at the first round, the beta user's cumulative information may comprise only the beta user's first response (inputted in S256) and the beta user's general information such as, non-exclusively, the location associated with the beta user's number, the types of devices, etc.

At the second round, the beta user's cumulative information may comprise the beta user's first response to the first question and second response to the second question, and any information associated with respective responses such as, non-exclusively, the dates and times of the responses, etc. As the beta user repeats the rounds, the cumulative information associated with the beta user increases.

At S259, the server may generate a message based on the beta user's cumulative information to send to the beta user. The beta user may then repeat the process to complete answering the question set, as shown in S260.

After the last question is complete and the beta user answers the last question, the server triggers the Mobile Commons mData to execute custom script, as shown in S262. This process may include exporting the cumulative data associated with the beta user from the Mobile Commons to the server and the server running a pre-set algorithm on the imported data to generate an outcome and/or summarize the beta user's answers.

At S263, the server may check the database in order to determine whether the beta user was invited by a different user (an alpha user). If the beta user was invited by an alpha user, the server may compile a message with the beta user's answers (e.g., the outcome and/or the summary of the answers calculated in S262) and send the message to the alpha user, as shown in S264.

If the beta user was not invited by an alpha user, the server may process and summarize the outcome to send to the beta user and also may prompt the beta user for share to a friend, as shown in S265. An exemplary message is shown in S266. If the beta user decides to invite another friend and sends a text including the friend's number, the friend becomes a beta user, and the beta user becomes the alpha user to the friend, and a similar process explained above may repeat, as shown in S267.

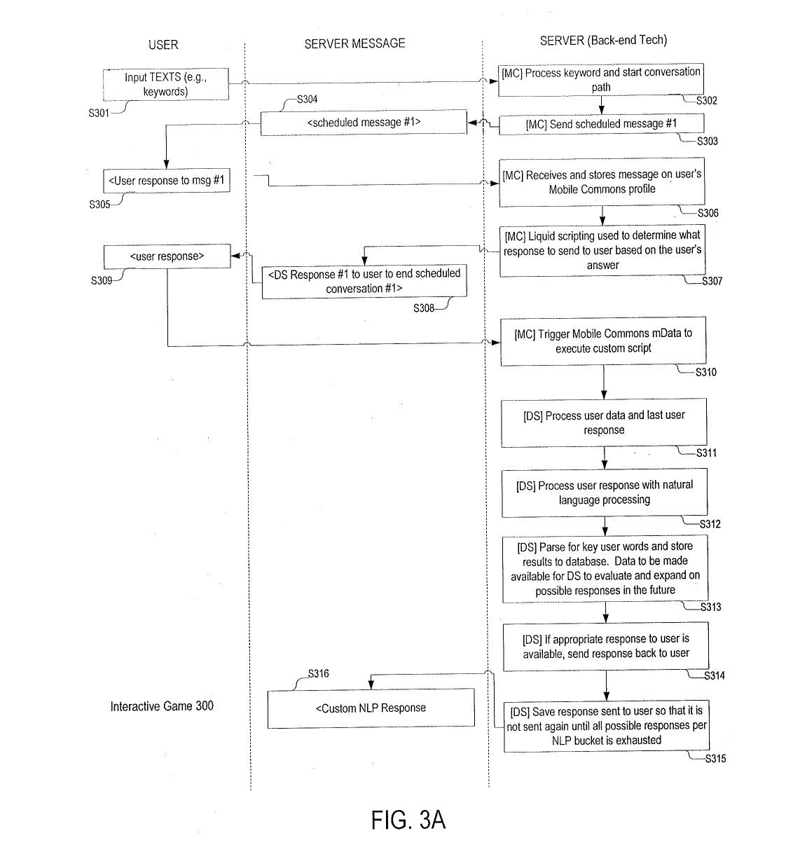

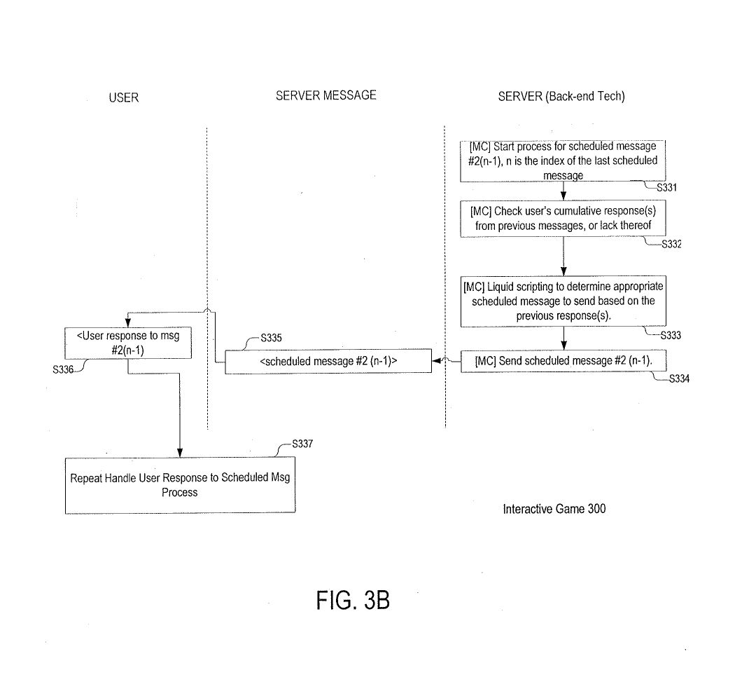

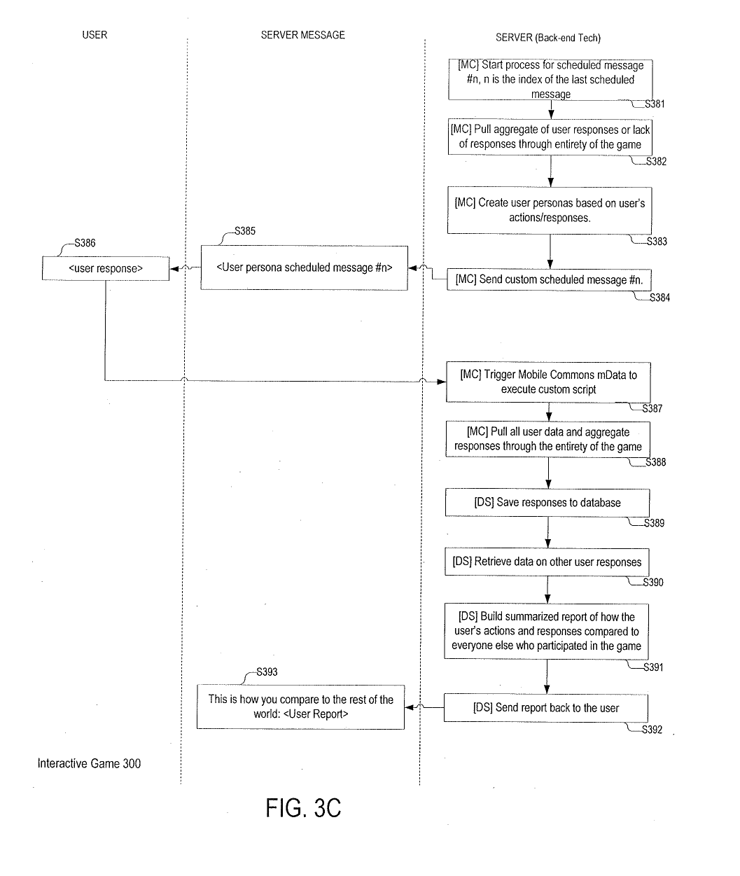

FIGS. 3A-3C illustrate an example of a processing flow chart of a text-based interactive game 300, in accordance with some embodiments described herein. FIG. 3A illustrates an exemplary processing flow chart of the first interactive path in the text-based interactive game 300, in accordance with some embodiments described herein. FIG. 3B illustrates an exemplary processing flow chart of the second interactive path through second to last interactive path in the text-based interactive game 300, in accordance with some embodiments described herein. FIG. 3C illustrates an exemplary flow chart of the last interactive path in the text-based interactive game 300, in accordance with some embodiments described herein.

The interactive game 300 may include the “Pregnancy Text Drip Message Game”, for example, challenging users to care for a phone-baby for a predetermined period utilizing a series of scheduled messages. Specifically, the users may interact with the experience with open-ended replies (e.g., text-based) and/or may invite friends to participate in the experience (e.g., invited friends may initiate their own experiences or take part in the same experience as the inviter).

The interactive game 300 may use scheduled messages to drive the core of an interactive user experience. To enhance reality and interactivity, the Natural Language systems may be used to provide smart custom responses to user messages.

The scheduling conditions of the messages may include, but are not limited to, a time of the day, a location associated with the current player (e.g., location of access point, area code of the phone number associated with the current player), or time lapsed from the last message sent to the player. The scheduling may be customized by individual players and/or the server.

FIG. 3A provides a simple example of how liquid scripting may be used to customize messages sent back to the user, based at least on the user's previous messages. The end of the flow chart also details how a National Language Processing (NLP) system may be connected to a conversation to catch and respond to additional user messages that are explicitly supported.

FIG. 3B provides another example of the schedules messages being dynamic. Using the liquid scripting, a scheduled message may be customized before getting sent to the user.

FIG. 3C provides an example of the interactive game 300 toward its end where an aggregate of all the user choices/responses/actions or lack of responses may be compiled to provide a single user-personal. This functionality may also be extended to aggregate the actions of all players nationwide or worldwide. The data may then be used to build a report to show how the user's decisions compared to others, which may further encourage offline conversation.

The interactive game 300 may comprise a plurality of interactive paths or conversation paths between the server and one or more users.

The user may initiate the experience by sending a text including keywords that are associated with initiation of the game 300, as shown in S301. For the “Pregnancy Text Drip Message Game,” the keywords may include “pregnancy” and/or “text,” etc. The server may store a correspondence table that associates games to their respective keywords.

Once the server receives and processes the keywords, it may start a conversation path, as shown in S302. Starting of a conversation path may include configuring to send a message associated with the called-for conversation path, as shown in S303. For example, for game 300, there may be a predetermined number of interactive and/or conversation paths that are to be played by users.

Once the first message to be sent is determined by the server for a given conversation path, the server sends that message (e.g., <scheduled message #1>) to the user, as shown in S304. The message may be scheduled in such ways that it is to be sent only at certain times/days, when the user is at certain locations, etc. Any further conditions may be added to the system by configuring the server, including but not limited to, the weather, the area-code of the user's number, the types of networks associated with the user's device, or any equivalent information that may be made available for utilization by the server.

After the user receives the message from the server, the user may input a text-based response to the message, as shown in S305. Upon receiving such response from the user, the server may store the user's response on the Mobile Commons in association with the user's profile, as shown in S306. Subsequently, the server may execute the liquid scripting to determine what should be sent back to the user, as shown in S307.

The liquid scripting may be done based on the user's previous answer/response/text, for example, by considering the types of words used, the tone and the length of the previous messages, etc. Further, the liquid template language stored in the Mobile Commons may be leveraged to create dynamic conversations based on the user responses. Alternatively or additionally, the liquid scripting may be configured to be similar to the one explained above with reference to the game 200.

Further, after generating a response to be sent to the user, the server then starts transmission of the generated message to the user (e.g., <DS Response #1 to user to end scheduled conversation #1>) and end the bi-directional interaction between the server and the user, as shown in S308. The user may respond to that message, as shown in S309.

Upon receiving the user's response, the server triggers the Mobile Commons mData to execute custom script, as shown in S310. Then, the server may process the user data (e.g., pulled from the Mobile Commons), as shown in S311. Here, the pulled user data may include the user's aggregate responses including the last response made in S309. The server processes the user's responses with natural language processing, as shown in S312.

The natural language processing system may be used to handle any additional messages from the user that may come after a preset structured conversation completes. Further, the system may also parse, tag, and/or store user responses to gather information about common user behavior. This may then help fine-tune portions of the game 300 and develop more robust experiences based on what the users are expecting and doing.

Simultaneously or subsequently, the server may also parse the keywords used in the user's response and store the results into the database associated with the user. These data may be made available for and/or by the server later, for example, to evaluate and expand on possible responses related to the user in future games. This process is represented in S313.

After the user's response is processed with natural language processing, the server may generate, store and/or send a customized response to the user, as shown in S314, S315, and S316. The message (e.g., <Custom NLP Response> shown in S316) may be customized based on the words used in the user's previous responses, frequency of certain words or phrases, context of the user's responses, generic information associated with the user and/or user data such as, for example, dates/times associated with the user's previous responses, area code of the user's recorded phone number, location of access point of current connection, etc. Such customization of the server responses/messages for individual users may increase the interactivity and reality of each user's experience.

FIG. 3B shows an exemplary processing flow chart for the second through the second-to-last interactive paths. As shown in S331, the Mobile Commons may process for the next scheduled message, for example, the second scheduled message for the second interactive path, the third scheduled message for the third interactive path, . . . (n−1) scheduled message for the (n−1) interactive path, where n represents the index of the last scheduled message and/or the last interactive path.

The scheduling of messages may be based on certain predetermined times of the day—for example, the second message may be scheduled to be sent at 11:00 AM, the second at 1:00 PM, the third at 3:00 PM, . . . the last message at 12:00 AM. Alternatively or additionally, the scheduling may be done relative to the timing of previous responses—for example, the second message may be scheduled to be sent after a certain number of hours/minutes from the user's response to the first message, and so on.

Further, the scheduling may be dynamically changed or updated on the server, or may be customized for each individual allowing each individual to select which scheduling method is to be used in his or her game. The scheduling may be stored in a storage unit of the server.

Still further, the content of scheduled messages to be sent throughout the course of a campaign (or a game) may be dynamically configured, for example, by utilizing a combination of technologies within the Mobile Commons platform. The customization of scheduled messages may be performed, for example, based on the user's choices in one or more previous conversations, the user's actions/responses previously made, user-associated information such as the user's location, area code of the user-associated number, user's recorded age/gender, etc.

Referring to FIG. 3B, after the Mobile Commons has selected the appropriate message that is scheduled to be sent to the user, it also checks the user's previous responses or lack thereof, as shown in S332. In this process, the Mobile Commons may incorporate the previous responses for creating a text message that will be sent to the user, where the text message not only includes the content of the scheduled message but also is consistent with the context of the ongoing interactive communications between the user and the server.

In other words, when the Mobile Commons realizes that it is time to send a next scheduled message and pulls that message from its storage unit, it does more than merely transmitting that pulled message to the user. It first may convert that message into a language that incorporates a part of the previous responses of the user, is consistent with a specific context of the interactive communication the user is currently participating, or otherwise is written in a customized manner to improve the user's interactive experience with the server.

This process may be implemented through the liquid scripting, as shown in S333. The liquid scripting process may be updated or modified (to consider more or fewer factors and/or to give different weights to different factors) on the server. Exemplary factors that may be considered include the content of the user's previous responses, time/date of the user's previous responses, location of the user at the time the previous responses were made, etc. Other factors may be further incorporated into the system as will be apparent to one of ordinary skill in the art.

The server subsequently sends the generated, customized message including the content of the scheduled message, as shown in S335. The user may respond to that message, as shown in S336. The handling of the user's response may be similar to the handling of user's response to the first message explained above with reference to FIG. 3A. For example, step S337 may comprise steps S306-S316 shown in FIG. 3A.

FIG. 3C shows an exemplary flow chart for the last interactive path. The Mobile Commons may start processing the last scheduled message according to a pre-determined schedule, as shown in S381. The last message is represented in the figure as the nth message, where n represents the index of the last scheduled message.

Subsequently, as shown in S382, the Mobile Commons may retrieve the aggregate responses that the user has previously transmitted or the user's lack of responses thereof through entirety of the game. Such pulled data may be used to create user personas (e.g., type of words or phrases that are frequently used in the user's actions or responses), as shown in S383.

The generation of user personas is a concept that is added to the idea of customizing a message based on the user's previous actions/responses and scheduled messages. Particularly, the user's response to the last scheduled message completes the cycle and therefore the server may pull an aggregate set of the user's actions, responses, or anything alike, through the entirety of a game to compile all the data in order to generate a persona corresponding to the user's observed/recorded behavior. For example, the persona may be used to indicate what kind of character the user was in any particular game.

The persona may be selected from a predetermined set of persona categories where each category is associated with predetermined factors and criteria (e.g., user responses made always within an hour from the transmittal of messages, user lacking responses for more than 3 messages, etc.), and the user's aggregate data may be analyzed to see whether the data matches with any particular category's criteria. The most-matched category may be selected as the user's persona. Alternatively or additionally, the user's persona may be generated from other open-ended algorithms, where the person would incorporate the words frequently used in the user's previous responses and types of actions frequently made.

Referring back to FIG. 3C, the generated user persona (customized language scripting) may be used to generate a message that includes the content of the last scheduled message and conforms to the particular context in which the user was in with the gaming interaction, as shown in S384. This may be referenced as custom scripting. The generated custom message may be then sent to the user, as shown in S385.

The user may further respond to the custom message, as shown in S386. If the user responds to the custom message, the receipt of such may trigger the Mobile Commons mData to execute the custom scripting, which includes pulling all user-associated data and aggregate responses made by the user through the entirety of the game, as shown in S387 and S388.

The pulled data may be sent to the [DS] level of processing by the server, where the pulled data may be saved to [DS] level database, which may be separate and distinct from the Mobile Commons mDATA, as shown in S389. Further, the [DS] may retrieve other users' responses from the [DS] database, as shown in S390, in order to ultimately generate a report on how the participating user's aggregate actions/responses are compared to other users who have participated in the same game, as shown in S391. The report may be sent to the user as shown in S392 and S393.

The above process may further allow connecting the user to a larger community pool by collating their data along with that of all the other users nationwide, based on which a report may be generated comparing any particular user's action to that of the rest of the users nationwide.

Further, the comparison report may be used, not only as a means for competition among different users, but also and more beneficially, as a means for allowing users to see how one's actions/responses are compared to that of others to generate more offline conversations and cause more awareness of relevant issues.

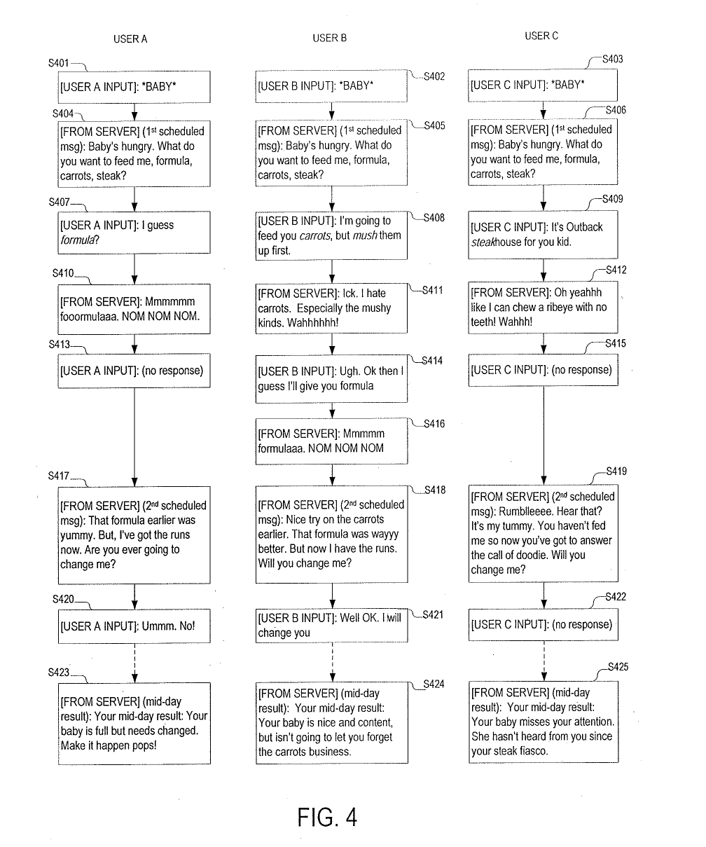

FIG. 4 illustrates exemplary scenarios for different users' text message interactions with the server, in accordance with some embodiments described in FIGS. 3A-3C. Specifically, FIG. 4 shows exemplary scenarios for three different users in a pregnancy-text-drip-message game.

As shown in S401, S402, and S403, three users (users A, B, and C) each input a text that includes the keyword (“baby”) and sends the text to the server to trigger initialization of the game corresponding to the inputted keyword. The text inputted by each of the users may be different, but as long as the text includes the same keyword, the same game corresponding to the keyword may be launched. Although not explicitly shown in the figure, if two or more keywords are recognized by the server, the server may request further confirmation from the user clarifying which keyword is the intended keyword, and launch the game corresponding to the intended keyword.

Referring to FIG. 4, once the same game is initialized for the users, the users each get a message that is scheduled to be sent as the first message at around the same time, as shown in S404, S405, and S406. The first scheduled message is not customized in this particular example, but may be customized based on the user-associated information previously stored in the server (e.g., user-characteristics previously defined from one or more different games the user has played before). Further, the schedule of timing when the first message is sent is the same (e.g., preset time, etc.) for each of the users in this particular example, but may be customized based on the user-associated information (e.g., user's time zone determined from user's current location).

Referring to FIG. 4, the first message puts each of the users in a situation where a baby needs to be fed, and forces the user to choose what is believed to be the most appropriate food for feeding the baby. User A chooses formula by inputting a text that includes the keyword “formula,” as shown in S407. User B chooses carrots by inputting a text that includes the corresponding keyword, as shown in S408. User C chooses steak by inputting a text that includes the corresponding keyword, as shown in S409.

The recognized keywords in this particular example are italicized in FIG. 4. As shown in S408, there may be more than one keyword that is recognized as representing the user's choice. User B's text includes two keywords—“carrots” and “mush,” both of which are used to represent the user's choice. Further, other phrases, words, and texts in the user's message that are not recognized as keywords are still recognized by the server and stored therein for determining the user's language style. This language style determined for individual users may be used by the server to generate a customized message for the corresponding user, and consequently improve interactive experience for the user.

Referring to FIG. 4, in response to the user's inputted message, the server generates a customized response for each of users A, B, and C, as shown in S410, S411, and S412, respectively. In response to the server's response, the users may further respond or not respond, and both the response and non-response are recognized by the server and stored therein in association with the corresponding user's game. In other words, both the response and non-response are counted as valid interactions by the user, which may be considered by the server later in generating a subsequent message. For example, for non-response interaction, the server may generate a message that refers to the user's non-response to a particular requested action and provides an appropriate consequence to that non-response.

In this example, user A does not respond, as shown in S413, user B responds with a corrected answer, as shown in S414, and user C does not respond, as shown in S415. In response to the answer by user B, the server may send a further response, as shown in S416. This answer, as shown in the example, is the same as the server message in S410, transmitted in response to the initial correct answer by user A, but may be customized based on user B's history of responses. For example, the server may consider user B's previous incorrect answer, and customize the response for user B as “Finally, you are giving me the right thing. Mmmmm. Formulaaaaa. Nom Nom Nom.”

Referring to FIG. 4, upon satisfaction of a condition for generating and transmitting a second scheduled message, the server determines which message is the second scheduled message based on the pre-stored information therein, and then pulls each of the user's aggregate message interactions to generate a customized second scheduled message. For example, the customized second scheduled message includes not only the pre-stored content to be used for the second scheduled message, but also the information that is specific to the user's past interaction. The examples of the customized message for users A, B, and C are shown, respectively, in S417, S418, and S419.

In response to the customized second scheduled message, the users may respond, as shown in S420, S421, and S422, and the response-recognition and generation and customization of the next scheduled message by the server may be repeated.

In this example shown in FIG. 4, there are only two scheduled messages for convenience of explanation only, and after the users' responses to the second scheduled message, the server generates a midday result, as shown in S423, S424, and S425. The midday result may be generated based on the user's aggregate responses, correctness of the user's responses indicating whether each of the user's responses was correct or incorrect, and if correct or incorrect, what the reasons are for such result, and if any incorrect answer exists, what should have been a more appropriate response, etc.

This result may provide educational information to the users that are customized for each of the users' choices, and consequently may serve as better training material for various social issues that are simulated by the game (e.g., the issue of pregnancy simulated by the pregnancy-text-drip-message game).

The flow of interactions shown in FIG. 4 is provided only as an example that is significantly simplified for convenience of explanation, and many further steps including sending numerous other scheduled messages may be added on to, or modified from, the system. Many different issues other than the issue of pregnancy may be simulated by the game, as will be apparent to one of ordinary skill in the art.

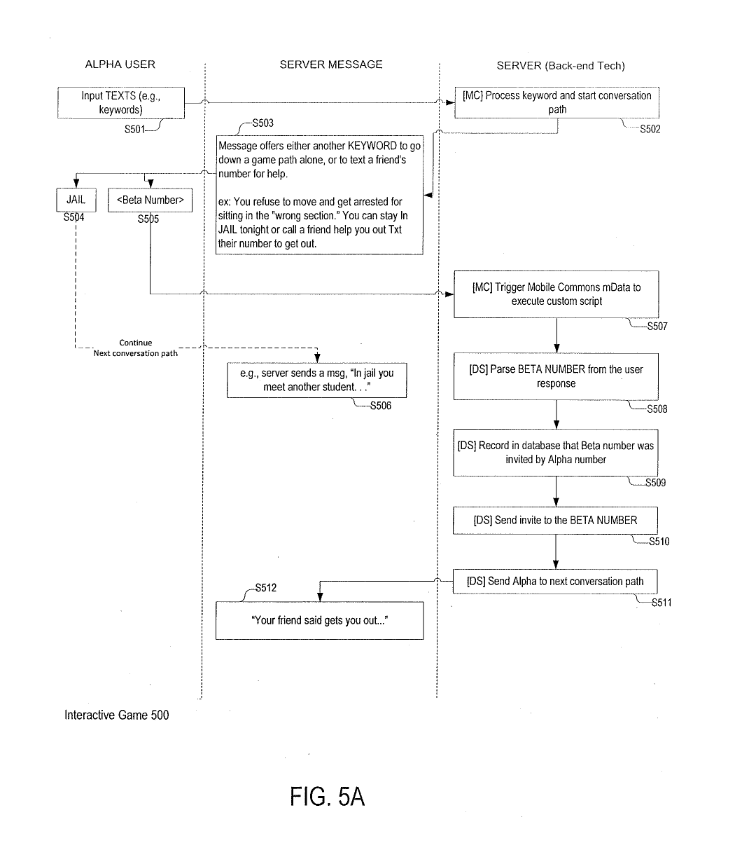

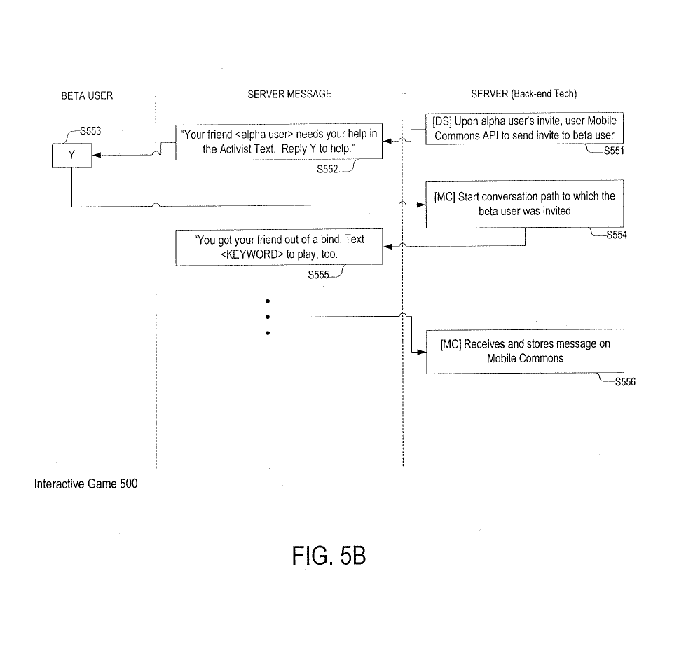

FIGS. 5A and 5B illustrate examples of a process flow chart of a text-based interactive game 500, in accordance with some embodiments described herein. FIG. 5A illustrates an exemplary processing flow for an alpha user, and FIG. 5B illustrates an exemplary processing flow for a beta user.

Specifically, the interactive game 500 may include the “Activist Text Game”, which utilizes keywords to create a story tree. Each keyword may offer a different branch for the user to follow down a tree. A story tree for a particular user may change depending on whether or not the player has invited a friend to join the game of the player, and the friend's subsequent responses/actions. The users may interact with the experience with open-ended replies (e.g., text-based) and/or may invite friends to participate in the experience (e.g., invited friends may initiate their own experiences or take part in the same experience as the inviter.

In other words, the interactive game 500 has a primary game player, alpha user, and one or more complementary players, beta users, whose responses and actions may affect the alpha user's game content and result.

FIG. 5A outlines an example of the experience for a user in the interactive game 500 presented with a choice to either continue alone or to invite a friend. The server may parse the friend's number from a message, send an invite, and forward the player down a path to continue their story.

FIG. 5B outlines an example of beta user's experience, where the beta user enters the interactive game 500 by receiving an invite from the previously described alpha user. One or more beta users may then be given context for what action and/or response they just took and be prompted to play the game 500 themselves.

Referring to FIG. 5A, the alpha user may initialize the game 500 by inputting and transmitting to the server a text including a keyword corresponding to the game 500, as shown in S501. The server may then process the keyword and start a conversation path defined for the game 500, as shown in S502. The message sent by the server may provide options to the user, either to input another keyword to go down the game path alone, or to text one or more friends' numbers for help (e.g., participation in the alpha user's game). An example of such message is shown in S503.

In S504, the user may choose to go down the game path alone without getting help from others (S504), or choose to ask for help from others (S505). If the former option is chosen, the server continues the interactive game path, as shown in S506. This path may be similar to the interactive game paths that are explained above with reference to games 200 or 300, and accordingly, further explanation for step S506 will be omitted.

If the latter option is chosen, the server triggers the Mobile Commons mData to execute custom scripting (S507), parse beta number(s) from the user's response (S508), record the response (including the beta numbers and other texts) (S509), send an invitation to the recorded beta numbers to help the alpha user (S510), and then send to the alpha user the next conversation path (S511). This next conversation path may be generated by the server based on the entire alpha and beta users' history of interactions, non-exclusively including the alpha user's previous responses and the beta user's acceptance/rejection to help out the alpha user with a particular situation, etc.

After the server determines the next conversation path for the alpha user, the server generates a customized message including the content of the determined next conversation path and the information specific to the player's history of interaction. In this particular example, the server may generate and send a message, as shown in S512, to the alpha user, referring to the alpha user's situation (e.g., jail) and beta user's acceptance to help the alpha user (e.g., getting the alpha user out from jail).

Referring to FIG. 5B, the server sends an invitation to the beta number transmitted by the alpha user. The transmission may be done through the Mobile Commons' API, as shown in S551. An example of the invitation message for the beta user is shown in S552. Other custom messages (e.g., describing the alpha user's situation, or the beta user's information if previously registered on the server) may be used. The beta user may respond positively, as shown in S553. The response that is triggered as an acceptance or a rejection may be customized in various ways, including, but not limited to, preregistered keywords (e.g., “yes”, “help”).

If the beta user accepts the invitation, the server may start the conversation path to which the beta user was invited by the alpha user, as shown in S554. The conversation path may describe the alpha user's situation in the game, and what type of help is needed from the beta user, etc. An example of such message is shown in S555.

A series of similar types of conversation paths may be provided to the beta user, offering various situations and conditions to participate in the alpha user's game and consequently affecting the alpha user's subsequent conversation path and the results of the game. At the end of the conversation path, the server may store all of the aggregate responses/actions taken by the beta user, as shown in S556.

The receiving of the beta user's messages and storing the messages may be implemented at the Mobile Commons. Such recorded information is associated with the alpha user, and is considered by the server in determining subsequent conversation path of the alpha user's game, including, but not limited to, the subsequent messages to be sent to the alpha user from the server, etc.

The games described above with reference to FIGS. 2A-5B are provided only as examples, and in particular, many different social issues other than the ones described herein may be simulated according to some embodiments of the interactive game to provide not only a fun and interactive text-based game but also an engaging and effective educational material to users.

From the foregoing it will be appreciated that, although specific embodiments of text-based interactive gaming (e.g., SMS, MMS, or the text-based system equivalent thereof) according to the claims are described herein for purposes of illustration, various modifications may be made without deviating from the spirit and core principle of the claimed subject matter.

What is claimed:

1. A server system for hosting an educational text-based interactive game for a plurality of mobile communication devices, the server system comprising:
a receiver that receives a first text from a first mobile communication device;
a message determination unit that determines a second text to be sent to the first mobile communication device in response to the first text, wherein the first mobile communication device responds to the second text to continue an interactive conversation path between the first mobile communication device and the server system;
a language scripter that customizes the second text based on, at least, a plurality of messages that have been received from the first mobile communication device during the game; and
a transmitter that transmits the customized second text to the first mobile communication device.

2. The server system of claim 1, wherein
the receiver receives a third text from a second communication device, and
the message determination unit determines the second text based on both the first text received from the first communication device and the third text received from the second communication device.

3. The server system of claim 1, wherein the texts exchanged between the first communication device and the server system are in SMS or MMS format.

4. The server system of claim 1, wherein the first mobile communication device includes a cellphone, a tablet computer, a PDA, or a device supporting SMS or MMS communication.

5. The server system of claim 1, wherein the language scripter customizes the second text based on information associated with each of the plurality of messages, the information including at least a time, date, or location associated with transmission or receipt of the respective messages.

6. The server system of claim 1, further comprising a storage medium that stores aggregate text messages that have been received from the first communication device,
wherein the language scripter customizes the second text based on, at least, a language style of all of the aggregate text messages stored on the storage medium, the language style including at least a frequency of a word, an average length of sentences, or a frequency of a grammar mistake.

7. The server system of claim 1, wherein the plurality of messages are an aggregate of all messages that have been received from the first mobile communication device.

8. The server system of claim 2, wherein the message determination unit determines the second text based on both an aggregate of texts previously received from the first communication device, including the first text, and an aggregate of texts previously received from the second communication device, including the third text.

9. The server system of claim 2, wherein the language scripter customizes the second text based on information associated with each of the aggregate of messages from the first and second communication devices, the information including at least a time, date, or location associated with transmission or receipt of the respective messages.

10. The server system of claim 1, further comprising a result-generator that generates a result of the game for the user of the first communication device based on at least a comparison of the aggregate texts received from the first communication device and aggregate texts received from other devices during the game.

11. The server system of claim 1, wherein the message-determination unit determines the second text among a plurality of scheduled messages, based on a scheduling condition associated with each of the messages.

12. The server system of claim 11, wherein the scheduling condition includes a time of the day, location associated with the first communication device, or time lapsed from a last message sent.

13. The server system of claim 1, wherein if the user of the first communication device does not respond to the second text sent by the server system within a predetermined amount of time, the server system recognizes the user's non-action, and
the message determination unit determines a subsequent message to be sent to the user based on at least the user's non-action.

14. A method for hosting an educational text-based interactive game for a plurality of communication devices, using a server system remotely connected to the communication devices, the method comprising:
receiving a first text from a first mobile communication device;
determining a second text to be sent to the first mobile communication device, in response to the first text, wherein the first mobile communication device responds to the second text to continue an interactive conversation path between the first mobile communication device and the server system;
customizing the second text based on, at least, a plurality of messages that have been received from the first mobile communication device during the game; and
transmitting the customized second text to the first mobile communication device.

15. The method of claim 14, further comprising:
receiving a third text from a second communication device,
wherein the second text is determined based on both an aggregate of texts previously received from the first communication device, including the first text, and an aggregate of texts previously received from the second communication device, including the third text.

16. The method of claim 14, wherein the texts exchanged between the first communication device and the server system are in SMS or MMS format.

17. The method of claim 14, wherein the first mobile communication device includes a cellphone, a tablet computer, a PDA, or a device supporting SMS or MMS communication.

18. The method of claim 14, wherein
the second text is determined by selecting one of a plurality of scheduled messages, based on a scheduling condition associated with each of the messages, and
the scheduling condition includes a time of the day, location associated with the first communication device, or time lapsed from a last message sent.

19. A non-transitory computer readable medium included in a server system with a processor and storing instructions thereon for hosting an educational text-based interactive gaming for a plurality of communication devices, when the instructions are executed, the server system is caused to perform:
receiving a first text from a first mobile communication device;
determining a second text to be sent to the first mobile communication device, in response to the first text, wherein the first mobile communication device responds to the second text to continue an interactive conversation path between the first mobile communication device and the server system;
customizing the second text based on, at least, a plurality of messages that have been received from the first mobile communication device during the game; and
transmitting the customized second text to the first mobile communication device.
